(19) United States
(12) Patent Application Publication
(10) Pub. No.: US 2017/0227566 A1
(43) Pub. Date: Aug. 10, 2017

(54) INERTIAL MEASUREMENT UNIT

(71) Applicant: Atlantic Inertial Systems, Limited, Plymouth (GB)

(72) Inventor: Christopher M. GREGORY, Plymouth (GB)

(21) Appl. No.: 15/424,969

(22) Filed: Feb. 6, 2017

(30) Foreign Application Priority Data
Feb. 8, 2016 (GB) 1602202.2

(51) Int. Cl. G01P 1/00; G01P 15/08; G01C 19/5776

(52) U.S. Cl. CPC G01P 1/006; G01C 19/5776; G01P 15/08; G01P 2015/0865

(57) ABSTRACT

An inertial measurement unit comprising at least one inertial sensor that is arranged to output an inertial measurement and a primary temperature sensor spatially associated with each inertial sensor that is arranged to output a temperature measurement, and a processor that receives the outputs; wherein the processor is arranged to differentiate the temperature measurement with respect to time so as to determine a temporal temperature gradient output. Existing temperature sensor(s) can be used to observe not only absolute temperature, but also thermal gradients, to further improve performance of the inertial measurement unit (IMU). This approach is distinct from the conventional calibration approach adopted for inertial sensors and IMUs in that the temperature sensor(s) in the device are used to determine temporal temperature gradients, in addition to a temperature output alone, one or both of which can be used for parametric compensation.

### FOREIGN PRIORITY

This application claims priority to United Kingdom Patent Application No. 1602202.2 filed Feb. 8, 2016, the entire contents of which is incorporated herein by reference.

### TECHNICAL FIELD

The present disclosure relates to an inertial measurement unit (IMU) and to methods of compensating for thermal gradients in an inertial measurement unit. In particular, but not exclusively, examples of the present disclosure relate to IMUs using a thermal ramp compensation scheme.

### BACKGROUND

Typically an inertial measurement unit (IMU) comprises multiple inertial sensors, such as accelerometers and/or gyroscopes, for measuring one or more axes of acceleration and/or angular rate. For example, an IMU providing a six degrees of freedom sensing system may comprise three orthogonal accelerometer axes and three gyroscopes. Compact, high performance IMUs usually comprise high grade MEMS (micro-electromechanical systems) gyroscopes and accelerometers integrated into a package that has dimensions of only around 50 mm. Such IMUs are expected to operate across a temperature range of −40° C. to +85° C.

Each sensing axis in a multiple sensing system comprises: the inertial sensor itself, such as a MEMS ring resonator gyroscope; the control electronics used to drive the sensor, such as an ASIC or analogue/digital loop electronics comprising discrete components; and a temperature sensor, such as a thermistor or an output from the sensor itself e.g. gyroscope resonant frequency. During conventional calibration and test, an inertial system is exposed to a range of temperatures in a stable thermal environment and parametric errors, such as bias error and scale factor error, can be observed in this stable thermal state. Compensation can thus be applied to remove such errors during operation and test.

The inertial sensors in IMUs are generally calibrated over their operating temperature range, but typically suffer from warm-up performance drift errors and hysteresis due to thermal gradients. Temperature gradients in the sensing structure can cause stress/strain characteristics that influence performance parameters, such as bias and scale factor. Temperature differences between the sensing elements, control electronics and temperature sensing elements may be small or consistent during calibration and test, providing minimal errors to be observed when certain thermal environmental conditions and start-up routines are met. However, during operation in unstable thermal environments or rapid start-up scenarios with significant self-heating effects, discrepancies in temperatures of components will cause sub-optimal thermal compensation and associated parametric errors in inertial sensor performance. Such errors are often characterised as ‘warm-up drift’ for gyroscope or accelerometer bias shift from switch on to steady state thermal operation or ‘hysteresis’ of output when thermally ramped in a thermal chamber or higher level operating system.

There remains a need for IMUs that can operate reliably even in unstable thermal environments where thermal gradients can affect performance parameters, such as bias and scale factor.

### SUMMARY

According to a first aspect of the present disclosure there is provided an inertial measurement unit comprising at least one inertial sensor that is arranged to output an inertial measurement and a primary temperature sensor spatially associated with each inertial sensor that is arranged to output a temperature measurement, and a processor that receives the outputs; wherein the processor is arranged to differentiate the temperature measurement with respect to time so as to determine a temporal temperature gradient output.

Thus according to this disclosure the existing temperature sensor(s) can be used to observe not only absolute temperature, but also thermal gradients, to further improve performance of the inertial measurement unit (IMU). This approach is distinct from the conventional calibration approach adopted for inertial sensors and IMUs in that the temperature sensor(s) in the device are used to determine temporal temperature gradients, in addition to a temperature output alone, one or both of which can be used for parametric compensation.

In at least some examples the processor is arranged to filter and/or smooth the differentiated temperature measurement so as to determine the temporal temperature gradient output. For example, a suitable filter may be applied to the differentiated temperature measurement and this output used as a temporal temperature gradient input to a compensation algorithm. For example, a suitable smoothing operation may be applied to the differentiated temperature measurement and this output used as a temporal temperature gradient input to a compensation algorithm.

In addition, a spatial approach to thermal gradient observation may be applied to provide a better insight into the temperature gradients experienced by a given IMU. Thus in preferred examples the inertial measurement unit further comprises one or more secondary temperature sensors that each has a different spatial location to the primary temperature sensor and is arranged to output a different temperature measurement, wherein the processor is arranged to process the different temperature measurements so as to determine a spatial temperature gradient output. This approach provides an additional spatial temperature gradient output which can be used during calibration to determine the parametric errors specifically induced by thermal gradients in the IMU.

Furthermore, in preferred examples the processor is further arranged to determine a compensation for the inertial measurement, or an associated parametric error, based on the temporal temperature gradient output and/or spatial temperature gradient output. The associated parametric error may comprise one or more parametric errors including bias error and scale factor error. It will be understood that bias error is the inertial measurement output by the inertial sensor in the absence of acceleration or rotation. It will be understood that scale factor error is the ratio of the change in inertial measurement output to a change in the true input (e.g. acceleration or rotation).

Both temporal and spatial approaches provide a temperature gradient output which can be used during calibration, preferably in conjunction with the conventional temperature output, to determine the parametric errors specifically induced by thermal gradients.

It will be appreciated that the spatial approach may also be used in its own right. Thus according to a second aspect of the present disclosure there is provided an inertial measurement unit comprising at least one inertial sensor that is arranged to output an inertial measurement, a primary temperature sensor spatially associated with each inertial sensor, and one or more secondary temperature sensors that each has a different spatial location to the primary temperature sensor, wherein each of the primary and secondary temperature sensors is arranged to output a different temperature measurement, and wherein the processor is arranged to process the different temperature measurements so as to determine a spatial temperature gradient output.

Thus according to this disclosure the instantaneous output from multiple (e.g. primary and one or more secondary) temperature sensors can be observed to infer a thermal gradient between them. This approach is ideally coupled with an understanding of the IMU system design, for example through thermal modelling, to associate the observed temperatures with a deeper understanding of how this data links to inferred temperatures in all parts of the system.

In various examples of any aspect of this disclosure, the at least one inertial sensor may comprise a MEMS-based inertial sensor.

The primary temperature sensor may be a physically separate temperature sensor (e.g. thermistor) located next to the inertial sensor, or the primary temperature sensor may be formed by the inertial sensor itself. In particular, it may be possible to measure temperature by observing a physical feature of the inertial sensor. For example, an inertial sensor comprising a vibrating structure gyroscope has an inherent ability to output a temperature measurement based on changes in the resonance frequency. Thus in some examples the inertial sensor comprises a vibrating structure gyroscope driven to resonance and the primary temperature sensor is arranged to output a temperature measurement based on the resonance frequency. Such a vibrating structure gyroscope may take the form of a ring resonator gyroscope or a tuning fork gyroscope.

In some other examples the inertial sensor comprises an accelerometer and the primary temperature sensor is arranged to measure temperature at, or near, the spatial location of the accelerometer. For example, the primary temperature sensor may comprise a thermistor located next to the accelerometer.

An inertial measurement unit comprising multiple inertial sensors may comprise at least one vibrating structure gyroscope and at least one accelerometer. Each of the inertial sensors may have its own spatially associated primary temperature sensor.

To fully realise the benefits of determining a spatial temperature gradient output, an appropriate configuration of secondary temperature sensors may be incorporated into the IMU design alongside a calibration process that enables sufficient observation of thermal gradients (both positive and negative) over the full operating temperature range. The one or more secondary temperature sensors may be spatially located anywhere in the inertial measurement unit, for example suitable locations within the sensor structure, electronics, and other locations that provide an insight into the thermal gradients observed.

In at least some examples the at least one inertial sensor comprises a MEMS substrate and at least one secondary temperature sensor is located on the MEMS substrate. For example, a secondary temperature sensor may comprise a thermistor in the form of metallised tracking on a surface of the MEMS substrate. Such an arrangement may enable temperature measurement through observation of resistivity changes with temperature.

In at least some examples, alternatively or in addition, the at least one inertial sensor comprises an integrated circuit and at least one secondary temperature sensor forms part of the integrated circuit. For example, a secondary temperature sensor may comprise a thermistor in or alongside electronic components such as pick off amps or forming part of an ASIC (application-specific integrated circuit).

In at least some examples, alternatively or in addition, the processor is located on a printed circuit board and at least one secondary temperature sensor is located on the same printed circuit board.

In at least some examples, alternatively or in addition, the inertial measurement unit may comprise an electrical connector for a host system, wherein at least one secondary temperature sensor is located at or on the electrical connector. For example, a secondary temperature sensor may comprise a thermistor arranged in a pin connector to the host system.

In an inertial measurement unit comprising multiple inertial sensors, each of the inertial sensors may have its own set of one or more associated secondary temperature sensors. Or at least some secondary temperature sensors may output a temperature measurement that is used to determine a spatial temperature gradient output for more than one inertial sensor.

According to a further aspect of the present disclosure there is provided a method of compensating for thermal gradients in an inertial measurement unit, comprising: receiving an inertial measurement output by at least one inertial sensor; receiving a temperature measurement output by a primary temperature sensor spatially associated with each inertial sensor; and differentiating the temperature measurement with respect to time so as to determine a temporal temperature gradient output.

In at least some examples, the method may further comprise: receiving a different temperature measurement output by one or more secondary temperature sensors that each has a different spatial location to the primary temperature sensor; and processing the different temperature measurements so as to determine a spatial temperature gradient output.

In at least some examples, alternatively or in addition, the method may further comprise: determining a compensation for the inertial measurement, or an associated parametric error, based on the temporal temperature gradient output and/or spatial temperature gradient output.

According to a yet further aspect of the present disclosure there is provided a method of compensating for thermal gradients in an inertial measurement unit, comprising: receiving an inertial measurement output by at least one inertial sensor; receiving a temperature measurement output by a primary temperature sensor spatially associated with each inertial sensor; receiving a different temperature measurement output by one or more secondary temperature sensors that each has a different spatial location to the primary temperature sensor; and processing the different temperature measurements so as to determine a spatial temperature gradient output.

### BRIEF DESCRIPTION OF DRAWINGS

One or more non-limiting examples will now be described, with reference to the accompanying drawings, in which:

FIG. 1 provides a schematic block diagram for a temporal thermal gradient compensation scheme in an IMU;

FIG. 2 shows the variation of inertial sensor temperature with time in an exemplary IMU;

FIG. 3 shows the differentiated temperature measurement from a primary temperature sensor spatially associated with the inertial sensor;

FIG. 4 shows smoothing of the temporal temperature gradient output;

FIG. 5 provides a schematic block diagram for a spatial thermal gradient compensation scheme in an IMU; and

FIGS. 6a-6c show examples of some spatial locations for the secondary temperature sensors in an IMU.

### DETAILED DESCRIPTION

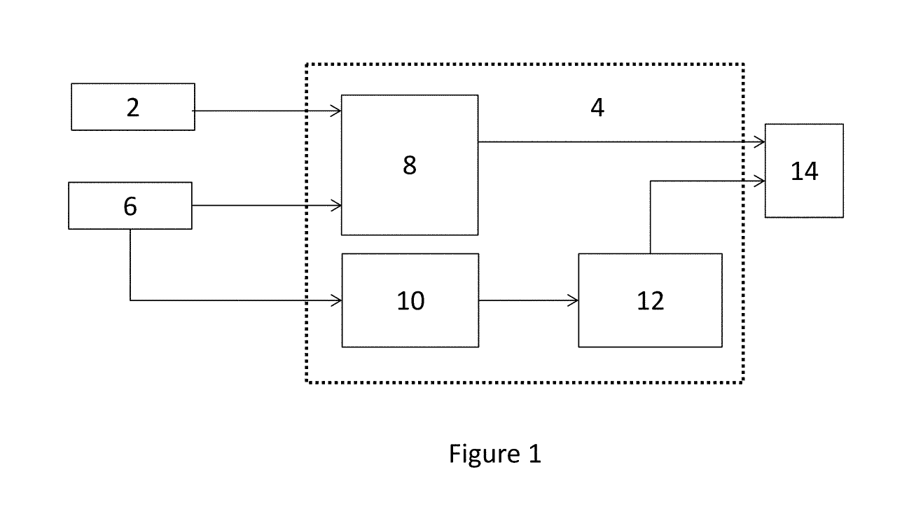

There is seen in FIG. 1 an inertial sensor 2 arranged to output an inertial measurement to a processor 4 in an IMU. A primary temperature sensor 6 spatially associated with the inertial sensor 2 is arranged to output a temperature measurement to the processor 4. As illustrated by block 8, the inertial measurement and the temperature measurement may be used by a conventional parametric compensation scheme to determine parametric errors during operation based on stable calibration and test conditions. According to examples of the present disclosure, the processor 4 carries out additional steps using the temperature measurement output by the primary temperature sensor 6. In block 10, the temperature measurement is differentiated with respect to time so as to determine a temporal temperature gradient output. This temporal temperature gradient output is fed to block 12 where a “thermal ramp” parametric compensation scheme additionally determines a compensation for the inertial measurement, or an associated parametric error, based on the temporal temperature gradient output. Block 10 may optionally include filtering and/or smoothing of the differentiated temperature measurement. The processor 4 then provides a compensated parametric output at block 14.

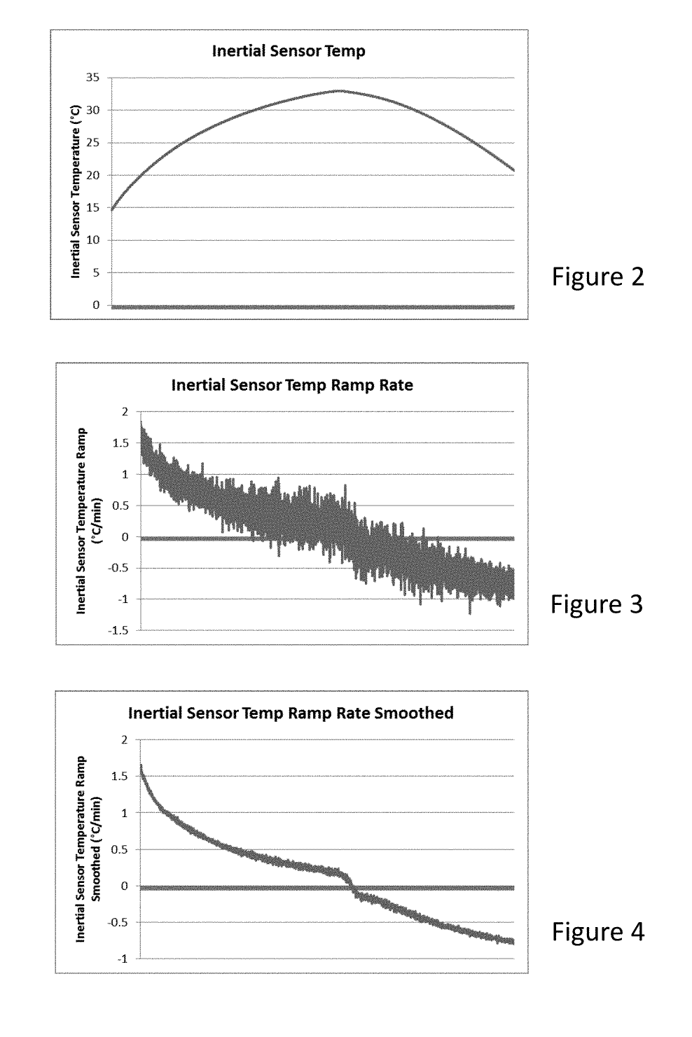

FIG. 2 shows how the temperature of the inertial sensor 2 may vary in time due to thermal gradient effects in the IMU. FIGS. 3 and 4 provide examples of the differentiated temperature measurement output by block 10, either as a raw measurement of temporal temperature gradient (FIG. 3) or after smoothing e.g. using a moving average filter (FIG. 4).

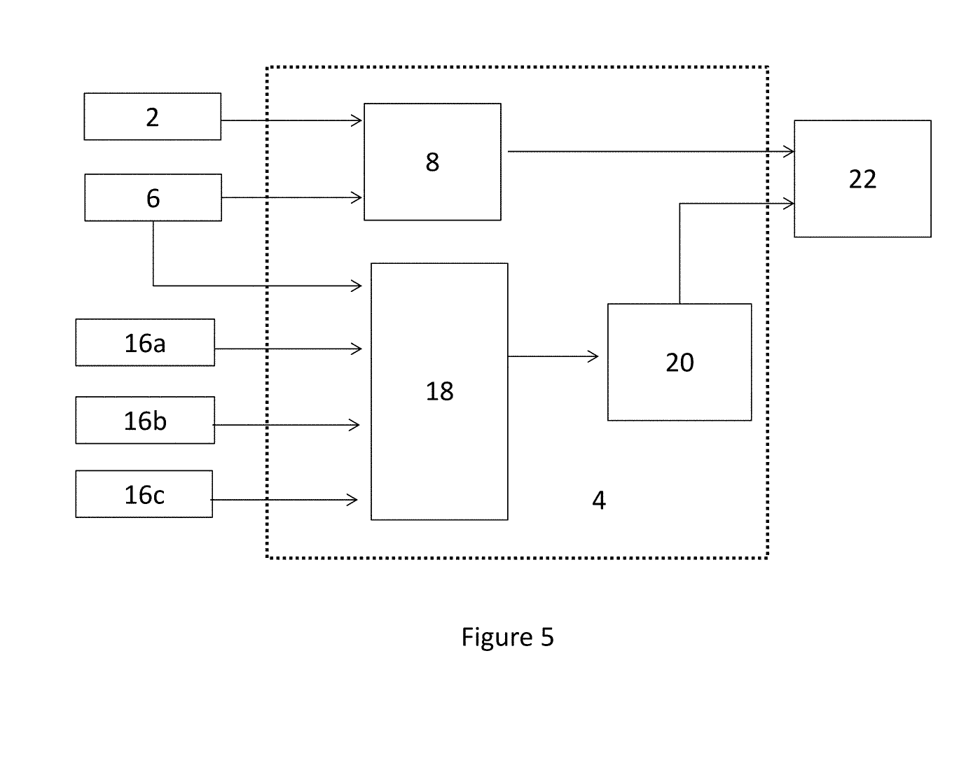

There is seen in FIG. 5 an inertial sensor 2 arranged to output an inertial measurement to a processor 4 in an IMU. A primary temperature sensor 6 spatially associated with the inertial sensor 2 is arranged to output a temperature measurement to the processor 4. As illustrated by block 8, the inertial measurement and the temperature measurement may be used by a conventional parametric compensation scheme to determine parametric errors during operation based on stable calibration and test conditions. According to examples of the present disclosure, the IMU further comprises secondary temperature sensors 16a, 16b, 16c each having a different spatial location to the primary temperature sensor 6, and ideally different spatial locations to one another. Each of the secondary temperature sensors 16a, 16b, 16c is arranged to output a different temperature measurement to block 18, where the processor 4 determines a spatial temperature gradient output. Block 18 may optionally include filtering of the different temperature measurements. At block 20 the processor 4 runs a “thermal ramp” parametric compensation scheme to additionally determine a compensation for the inertial measurement, or an associated parametric error, based on the spatial temperature gradient output. The processor 4 then provides a compensated parametric output at block 22.

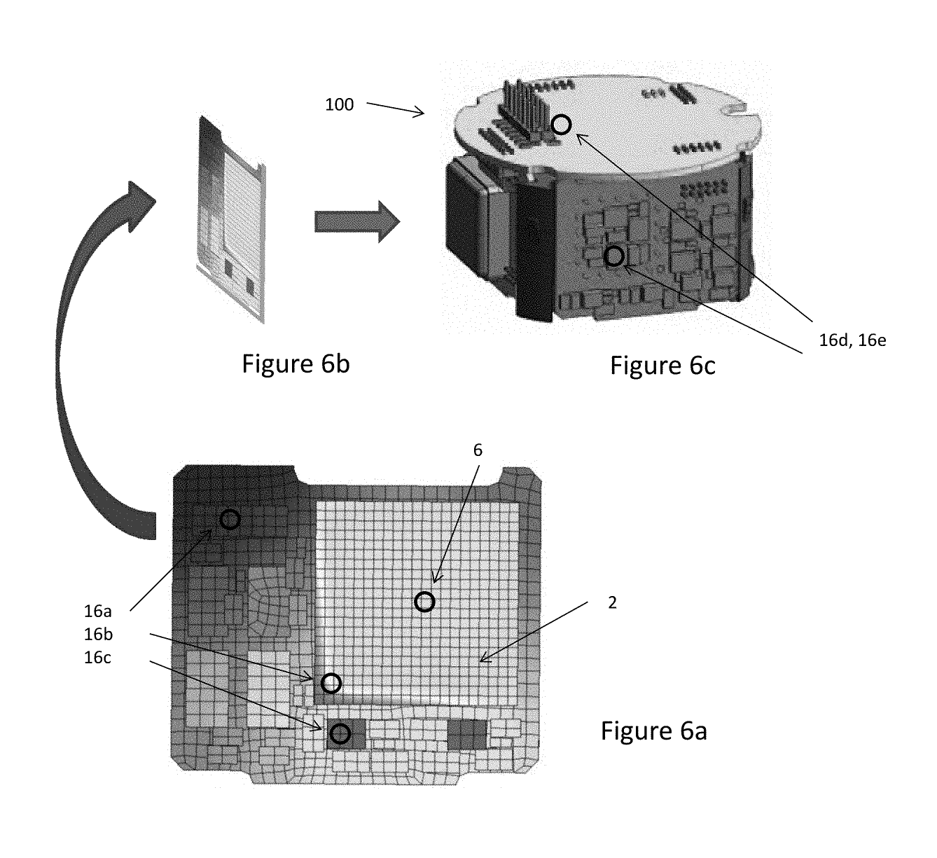

FIGS. 6a to 6c illustrate an inertial sensor 2 located on one side of an inertial measurement unit (IMU) 100. The inertial sensor 2, which may be a MEMS-based vibrating structure gyroscope or an accelerometer, comprises a primary temperature sensor 6 having the same spatial location. In addition to the primary temperature sensor 6, three secondary temperature sensors 16a, 16b, 16c are positioned at various different spatial locations around the inertial sensor 2. For example, the secondary temperature sensors 16a, 16b, 16c may be placed on the PCB to which the inertial sensor 2 is mounted. As seen from FIG. 6c, further secondary temperature sensors 16d, 16e may be positioned in other spatial locations on other sides of the IMU. These locations will typically be chosen on known thermal pathways that provide greatest assistance in observing the thermal gradients being applied to the IMU during operation e.g. in an unstable environment.

It will be appreciated that the two thermal ramp compensation schemes seen in FIGS. 1 and 5, respectively, may of course be combined in a single processor 4.

1. An inertial measurement unit comprising at least one inertial sensor that is arranged to output an inertial measurement and a primary temperature sensor spatially associated with each inertial sensor that is arranged to output a temperature measurement, and a processor that receives the outputs; wherein the processor is arranged to differentiate the temperature measurement with respect to time so as to determine a temporal temperature gradient output.

2. The inertial measurement unit of claim 1, wherein the processor is arranged to filter and/or smooth the differentiated temperature measurement so as to determine the temporal temperature gradient output.

3. The inertial measurement unit of claim 1, further comprising one or more secondary temperature sensors that each has a different spatial location to the primary temperature sensor and is arranged to output a different temperature measurement, wherein the processor is arranged to process the different temperature measurements so as to determine a spatial temperature gradient output.

4. The inertial measurement unit of claim 1, wherein the processor is further arranged to determine a compensation for the inertial measurement, or an associated parametric error, based on the temporal temperature gradient output and/or spatial temperature gradient output.

5. An inertial measurement unit comprising at least one inertial sensor that is arranged to output an inertial measurement, a primary temperature sensor spatially associated with each inertial sensor, and one or more secondary temperature sensors that each has a different spatial location to the primary temperature sensor, wherein each of the primary and secondary temperature sensors is arranged to output a different temperature measurement, and wherein the processor is arranged to process the different temperature measurements so as to determine a spatial temperature gradient output.

6. The inertial measurement unit of claim 1, wherein the inertial sensor comprises a vibrating structure gyroscope driven to resonance and the primary temperature sensor is arranged to output a temperature measurement based on the resonance frequency.

7. The inertial measurement unit of claim 1, wherein the inertial sensor comprises an accelerometer and the primary temperature sensor is arranged to measure temperature at, or near, the spatial location of the accelerometer.

8. The inertial measurement unit of claim 1, wherein the at least one inertial sensor comprises a MEMS substrate and at least one secondary temperature sensor is located on the MEMS substrate.

9. The inertial measurement unit of claim 1, wherein the at least one inertial sensor comprises an integrated circuit and at least one secondary temperature sensor forms part of the integrated circuit.

10. The inertial measurement unit of claim 1, wherein the processor is located on a printed circuit board and at least one secondary temperature sensor is located on the same printed circuit board.

11. The inertial measurement unit of claim 1, further comprising an electrical connector for a host system, wherein at least one secondary temperature sensor is located at or on the electrical connector.

12. A method of compensating for thermal gradients in an inertial measurement unit, comprising:
receiving an inertial measurement output by at least one inertial sensor;
receiving a temperature measurement output by a primary temperature sensor spatially associated with each inertial sensor; and
differentiating the temperature measurement with respect to time so as to determine a temporal temperature gradient output.

13. The method of claim 12, further comprising:
receiving a different temperature measurement output by one or more secondary temperature sensors that each has a different spatial location to the primary temperature sensor; and
processing the different temperature measurements so as to determine a spatial temperature gradient output.

14. The method of claim 12, further comprising:
determining a compensation for the inertial measurement, or an associated parametric error, based on the temporal temperature gradient output and/or spatial temperature gradient output.
